(19) United States
(12) Patent Application Publication
(10) Pub. No.: US 2017/0316578 A1
(43) Pub. Date: Nov. 2, 2017

(54) Method, System and Device for Direct Prediction of 3D Body Poses from Motion Compensated Sequence

(71) Applicant: ECOLE POLYTECHNIQUE FEDERALE DE LAUSANNE (EPFL), Lausanne (CH)

(72) Inventors: Pascal Fua, Vaux-sur-Morges (CH); Vincent Lepetit, Graz (AT); Artem Rozantsev, Lausanne (CH); Bugra Tekin, Saint-Sulpice (CH)

(21) Appl. No.: 15/498,558

(22) Filed: Apr. 27, 2017

Related U.S. Application Data
(60) Provisional application No. 62/329,211, filed on Apr. 29, 2016.
(60) Provisional application No. 62/329,211, filed on Apr. 29, 2016.

(51) Int. Cl. G06T 7/73; G06T 7/246

(52) U.S. Cl. CPC G06T 7/73; G06T 7/246

(57) ABSTRACT

A method for predicting three-dimensional body poses from image sequences of an object, the method performed on a processor of a computer having memory, the method including the steps of accessing the image sequences from the memory, finding bounding boxes around the object in consecutive frames of the image sequence, compensating motion of the object to form spatio-temporal volumes, and learning a mapping from the spatio-temporal volumes to a three-dimensional body pose in a central frame based on a mapping function.

### CROSS-REFERENCE TO RELATED APPLICATIONS

The present application claims priority to the United States provisional patent application with the Ser. No. 62/329,211 that was filed on Apr. 29, 2016, the entire contents thereof herewith incorporated by reference.

### FIELD OF THE INVENTION

The present invention relates to the field of image processing and motion image sequence processing, more particularly, to the field of motion estimation, detection, and prediction of body poses.

### BRIEF DISCUSSION OF THE BACKGROUND ART

In recent years, impressive motion capture results have been demonstrated using depth cameras, but three-dimensional (3D) body pose recovery from ordinary monocular video sequences remains extremely challenging. Nevertheless, there is great interest in doing so, both because cameras are becoming ever cheaper and more prevalent and because there are many potential applications. These include athletic training, surveillance, and entertainment.

Early approaches to monocular 3D pose tracking involved recursive frame-to-frame tracking and were found to be brittle, due to distractions and occlusions from other people or objects in the scene [43]. Since then, the focus has shifted to “tracking by detection” which involves detecting human pose more or less independently in every frame followed by linking the poses across the frames [2, 31], which is much more robust to algorithmic failures in isolated frames. More recently, an effective single-frame approach to learning a regressor from a kernel embedding of two-dimensional (2D) HOG features to 3D poses has been proposed by [17], hereinafter referred to as Ionescu. Excellent results have also been reported using a Convolutional Neural Net (CNN) [25], hereinafter referred to as Li.

However, inherent ambiguities of the projection from 3D to 2D, including self-occlusion and mirroring, can still confuse these state-of-the-art approaches. A linking procedure can correct for these ambiguities to a limited extent by exploiting motion information a posteriori to eliminate erroneous poses by selecting compatible candidates over consecutive frames. However, when such errors happen frequently for several frames in a row, enforcing temporal consistency afterwards is not enough. Therefore, in light of these deficiencies of the background art, strongly improved methods, devices, and systems are desired.

### SUMMARY

According to one aspect of the present invention, a method for predicting three-dimensional body poses from image sequences of an object is provided, the method performed on a processor of a computer having memory. Preferably, the method includes the steps of accessing the image sequences from the memory, finding bounding boxes around the object in consecutive frames of the image sequence, compensating motion of the object to form spatio-temporal volumes, and learning a mapping from the spatio-temporal volumes to a three-dimensional body pose in a central frame based on a mapping function.

According to another aspect of the present invention, a device for predicting three-dimensional body poses from image sequences of an object is provided, the device including a processor having access to a memory. Preferably, the processor configured to access the image sequences from the memory, find bounding boxes around the object in consecutive frames of the image sequence, compensate motion of the object to form spatio-temporal volumes, and learn a mapping from the spatio-temporal volumes to a three-dimensional body pose in a central frame based on a mapping function.

According to still another aspect of the present invention, a non-transitory computer readable medium is provided. Preferably, the computer readable medium has computer instructions recorded thereon, the computer instructions configured to perform a method for predicting three-dimensional body poses from image sequences of an object when executed on a computer having memory. Moreover, the method further preferably includes the steps of accessing the image sequences from the memory, finding bounding boxes around the object in consecutive frames of the image sequence, compensating motion of the object to form spatio-temporal volumes, and learning a mapping from the spatio-temporal volumes to a three-dimensional body pose in a central frame based on a mapping function.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE SEVERAL VIEWS OF THE DRAWINGS AND TABLES

The accompanying drawings, together with the tables, which are incorporated herein and constitute part of this specification, illustrate the presently preferred embodiments of the invention, and together with the general description given above and the detailed description given below, serve to explain features of the invention:

FIG. 1 schematically shows human pose estimations in Human3.6m, HumanEva and KTH Multiview Football datasets. The recovered 3D skeletons are reprojected into the images in the top row and shown by themselves in the bottom row. The present method can reliably recover 3D poses in complex scenarios by collecting appearance and motion evidence simultaneously from motion compensated sequences;

FIGS. 2A-2C schematically depict an overview of the method for 3D pose estimation, with FIG. 2A showing on the left side that a person is detected in several consecutive frames of an image stack, in the middle, using a convolutional neuronal network (CNN), the corresponding image windows are shifted so that the subject remains centered for motion compensation, an on the right, a rectified spatiotemporal volume (RSTV) is formed by concatenating the aligned windows, FIG. 2B shows, on the left side, the aligned windows, and on the right, a pyramid of 3D HOG features are extracted densely over the volume, to extract spatio-temporal features, and FIG. 2C shows the 3D pose in the central frame is obtained by regression;

FIG. 3 shows a schematic view of a flow chart that represent the steps of the method according to one aspect of the present invention, the steps of the method can be performed by a system or a device;

FIGS. 4A and 4B show heat maps of the gradients across all frames for greeting action without motion compensation (FIG. 4A) and with motion compensation (FIG. 4B). When motion compensation is applied, body parts become covariant with the 3D histogram of oriented gradients (HOG) cells across frames and thus the extracted spatiotemporal features become more part-centric and stable;

FIG. 5 schematically depicts a simplified representation of the motion compensation CNN architecture. The network includes convolution, depicted by the references numerals C1, C2 and C3, pooling, depicted by reference numerals P2 and P3, and fully connected layers, depicted by reference numerals FC1 and FC2. The output of the network is a two-dimensional vector that describes horizontal and vertical shifts of the person from the center of the patch;

FIGS. 6A to 6C show representations of pose estimation results on Human3.6m. The rows correspond to the Buying, Discussion and Eating actions. FIG. 6A show the reprojection in the original images and projection on the orthogonal plane of the ground-truth skeleton for each action. FIG. 6B shows the skeletons recovered by the approach of Ionescu, and FIG. 6C shows the skeletons recovered by the present method. Note that our method can recover the 3D pose in these challenging scenarios, which involve significant amounts of self occlusion and orientation ambiguity.

FIGS. 7A to 7D show representations of the 3D human pose estimation methods with different regressors on Human3.6m, with FIG. 7A showing a reprojection in the original images and projection on the orthogonal plane of the ground truth skeletons for Walking Pair action class, FIG. 7B showing the 3D body pose recovered using the KRR regressor applied to RSTV, FIG. 7C showing the 3D body pose recovered using the KDE regressor applied to RSTV, and FIG. 7D showing the 3D body pose recovered using the DN regressor applied to RSTV;

FIG. 8 schematically shows results on HumanEva-I. The recovered 3D poses and their projection on the image are shown for Walking and Boxing actions;

FIGS. 9A to 9C show results of KTH Multiview Football II. The 3D skeletons are recovered from Camera 1 images (FIG. 9A) and projected on those of Camera 2 (FIG. 9B) and Camera 3 (FIG. 9C), which were not used to compute the poses; and

FIG. 10 shows a schematic perspective view of an exemplary device of system for implementing the method herein;

Table 1 shows different results of 3D joint position errors in Human3.6m using the metric of average Euclidean distance;

Table 2 shows different results for two actions, one for the Walking Dog having more movement, and one for the Greeting action with less motion;

Table 3 shows different results that demonstrates the influence of the size of the temporal window;

Table 4 shows different results of 3D joint position errors (in mm) on the Walking and Boxing sequences of the HumanEva-I dataset;

Table 5 shows different results of 3D joint position errors (in mm) on the Combo sequence of the HumanEva-II dataset; and

Table 6 shows a comparison on the KTH Multiview Football II results of the present method using a single camera to those of using either single or two cameras.

Herein, identical reference numerals are used, where possible, to designate identical elements that are common to the figures. Also, the representations in the drawings are simplified for illustration purposes and may not be depicted to scale.

### DISCUSSION OF THE SEVERAL EMBODIMENTS

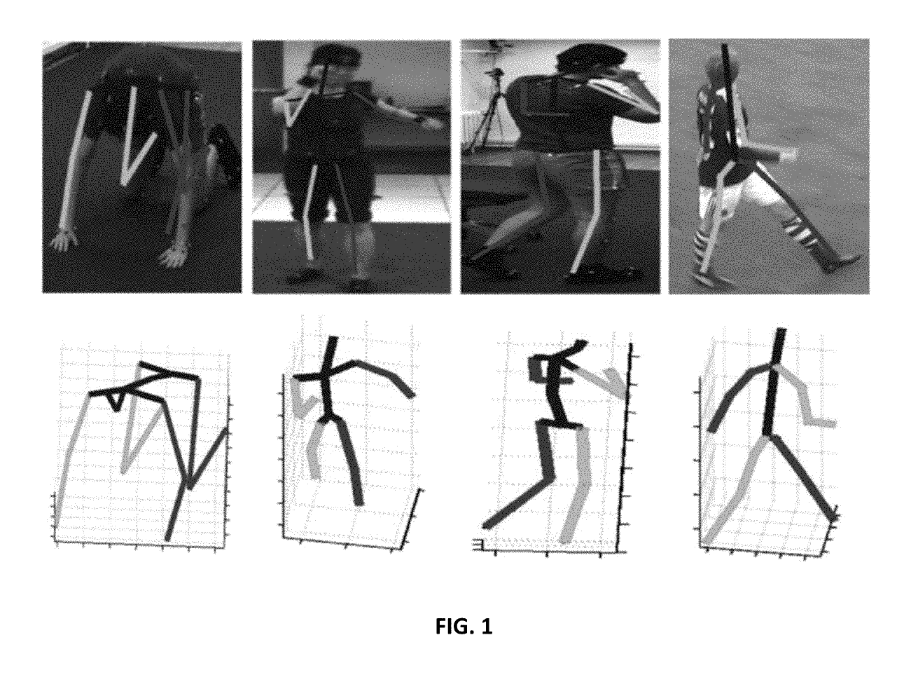

According to one aspect of the present invention, motion information is used from the start of the process. To this end, we learn a regression function that directly predicts the 3D pose in a given frame of a sequence from a spatio-temporal volume centered on it. This volume comprises bounding boxes surrounding the person in consecutive frames coming before and after the central one. It is shown that this approach is more effective than relying on regularizing initial estimates a posteriori. Different regression schemes have been evaluated and the best results are obtained by applying a Deep Network to the spatiotemporal features [21, 45] extracted from the image volume. Furthermore, we show that, for this approach to perform to its best, it is essential to align the successive bounding boxes of the spatio-temporal volume so that the person inside them remains centered. To this end, we trained two Convolutional Neural Networks to first predict large body shifts between consecutive frames and then refine them. This approach to motion compensation outperforms other more standard ones [28] and improves 3D human pose estimation accuracy significantly. FIG. 1 depicts sample results of the present method.

According to another aspect of the present method, device and system, one advantage is a principled approach to combining appearance and motion cues to predict 3D body pose in a discriminative manner. Furthermore, it is demonstrated that what makes this approach both practical and effective is the compensation for the body motion in consecutive frames of the spatiotemporal volume. It is shown that the proposed method, device and system substantially improves upon background methods [2, 3, 4, 17, 25] by a large margin on Human3.6m of Ionescu [25], HumanEva [36], and KTH Multiview Football [6] 3D human pose estimation benchmarks.

Approaches to estimating the 3D human pose can be classified into two main categories, depending on whether they rely on still images or image sequences. These two categories are briefly discussed infra. In the results shown infra, it is demonstrated that the present method, device, and system outperforms the background art representatives of each of these two categories.

With respect to the first category, the 3D human pose estimation in single images, early approaches tended to rely on generative models to search the state space for a plausible configuration of the skeleton that would align with the image evidence [12, 12, 27, 35]. These methods remain competitive provided that a good enough initialization can be supplied. More recent ones [3, 6] extend 2D pictorial structure approaches [10] to the 3D domain. However, in addition to their high computational cost, they tend to have difficulty localizing people's arms accurately because the corresponding appearance cues are weak and easily confused with the background [33].

By contrast, discriminative regression-based approaches [1, 4, 16, 40] build a direct mapping from image evidence to 3D poses. Discriminative methods have been shown to be effective, especially if a large training dataset, such as in Ionescu is available. Within this context, rich features encoding depth [34] and body part information [16, 25] have been shown to be effective at increasing the estimation accuracy. However, these methods can still suffer from ambiguities such as self-occlusion, mirroring and foreshortening, as they rely on single images. To overcome these issues, the present application shows how to use not only appearance, but also motion features for discriminative 3D human pose estimation purposes.

In another notable study, [4] investigates merging image features across multiple views. Our method is fundamentally different as we do not rely on multiple cameras. Furthermore, we compensate for apparent motion of the person's body before collecting appearance and motion information from consecutive frames.

With respect to the second category, the 3D human pose estimation in image sequences, these approaches also fall into two main classes.

The first class involves frame-to-frame tracking and dynamical models [43] that rely on Markov dependencies on previous frames. Their main weakness is that they require initialization and cannot recover from tracking failures.

To address these shortcomings, the second class focuses on detecting candidate poses in individual frames followed by linking them across frames in a temporally consistent manner. For example, in [2], initial pose estimates are refined using 2D tracklet-based estimates. In [47], dense optical flow is used to link articulated shape models in adjacent frames. Non-maxima suppression is then employed to merge pose estimates across frames in [7]. By contrast to these approaches, in the present method, device, and system, the temporal information is captured earlier in the process by extracting spatiotemporal features from image cubes of short sequences and regressing to 3D poses. Another approach [5] estimates a mapping from consecutive ground-truth 2D poses to a central 3D pose. Instead, the present method, device, and system does not require any such 2D pose annotations and directly use as input a sequence of motion-compensated frames.

While they have long been used for action recognition [23, 45], person detection [28], and 2D pose estimation [11], spatiotemporal features have been underused for 3D body pose estimation purposes. The only recent approach is [46] that involves building a set of point trajectories corresponding to high joint responses and matching them to motion capture data. One drawback of this approach is its very high computational cost. Also, while the 2D results look promising, no quantitative 3D results are provided in the paper and no code is available for comparison purposes.

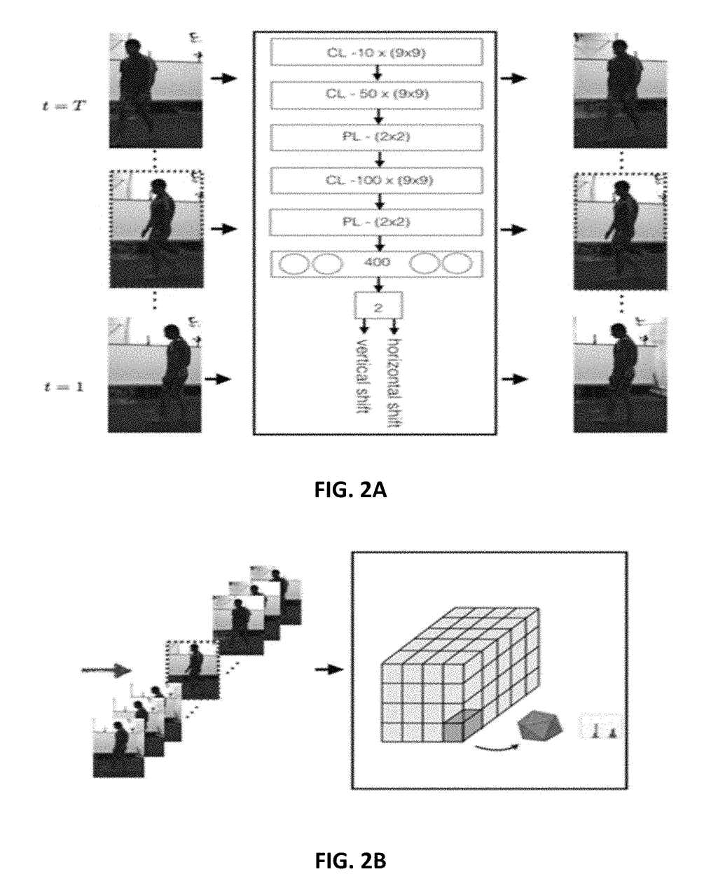

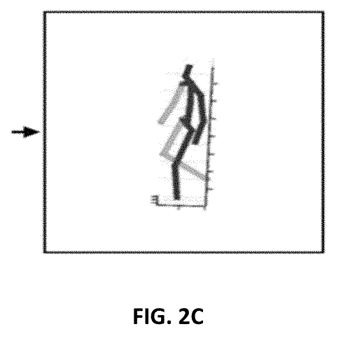

According to one aspect of the present method, device, and system, the approach involves finding bounding boxes around people in consecutive frames, compensating for the motion to form spatiotemporal volumes, and learning a mapping from these volumes to a 3D pose in their central frame. In the following discussion, the formalism and terms used in the present application are presented and then describe each individual step, depicted by FIGS. 2A to 2C.

According to one aspect of the proposed method, device, and system, an efficient approach to exploiting motion information from consecutive frames of a video sequence to recover the 3D pose of people is provided. Previous approaches typically compute candidate poses in individual frames and then link them in a post-processing step to resolve ambiguities. By contrast, with one aspect of the present method, device, and system, regress from a spatio-temporal volume of bounding boxes to a 3D pose in the central frame.

In addition, it is show that, for the present method, device and system to achieve its full potential, it is preferable to compensate for the motion in consecutive frames so that the subject remains centered. This then allows us to effectively overcome ambiguities and improve upon the state-of-the-art by a large margin on the Human3.6m, HumanEva, and KTH Multiview Football 3D human pose estimation benchmarks.

In the present application, 3D body poses are represented in the figures in terms of skeletons, such as those shown in FIG. 1, and the 3D locations of their D joints relative to that of a root node. As several authors before [4, 17], this representation is chosen because it is well adapted to regression and does not require knowing a priori the exact body proportions of the subjects. It suffers from not being orientation invariant but using temporal information provides enough evidence to overcome this difficulty.

Let Iᵢ be the i-th image of a sequence containing a subject and Yᵢε [symbol] ^{3.D} be a vector that encodes the corresponding 3D joint locations. Typically, regression-based discriminative approaches to inferring Yᵢ involve learning a parametric [1, 18] or non-parametric [42] model of the mapping function, Xᵢ→Yᵢ≈f(Xᵢ) over training examples, where Xᵢ=Ω(Iᵢ; m₁) is a feature vector computed over the bounding box or the foreground mask, mᵢ, of the person in Iᵢ. The model parameters are usually learned from a labeled set of N training examples, T={(Xᵢ, Yᵢ)}ᵢ₌₁^{N}. As discussed supra, in such a setting, reliably estimating the 3D pose is hard to do due to the inherent ambiguities of 3D human pose estimation such as self-occlusion and mirror ambiguity.

Instead, the mapping function f is modelled conditioned on a spatiotemporal 3D data volume that is made of a sequence of T frames centered at image i,

Vᵢ=[I_{i-T/2+1}, . . . ,Iᵢ, . . . ,I_{i+T/2}] (1)

Zᵢ→Yᵢ≈f(Zᵢ) (2)

where

Zᵢ=ξ(Vᵢ;m_{i-T/2+1}, . . . ,mᵢ, . . . ,m_{i+T/2}) (3)

Zᵢ is a feature vector computed over the data volume, Vᵢ. The training set, in this case, is:

T={(Zᵢ,Yᵢ)}ᵢ₌₁^{N} (4)

where Yᵢ is the pose in the central frame of the image stack. In practice, every block of consecutive T frames are collected across all training videos to obtain data volumes. It is shown that in the results section that this significantly improves performance and that the best results are obtained for volumes of T=24 to 48 images, that is 0.5 to 1 second given the 50 fps of the sequences of the Human3.6m dataset of Ionescu.

Regarding the spatiotemporal features, the feature vector Z is based on the 3D histogram of oriented gradients (HOG) descriptor [45], which simultaneously encodes appearance and motion information. It is computed by first subdividing a data volume such as the one depicted by FIG. 2A into equally-spaced cells. For each one, the histogram of oriented 3D spatio-temporal gradients [21] is then computed. To increase the descriptive power, a multi-scale approach is used. Several 3D histogram of oriented gradients (HOG) descriptors are computed using volume cells, in spatial and temporal direction, having different cell sizes. In practice, we use three (3) levels in the spatial dimensions, 2×2, 4×4 and 8×8, and the temporal cell size is set to a small value, for example four (4) frames for 50 fps videos, to capture fine temporal details. The final feature vector Z is obtained by concatenating the descriptors at multiple resolutions into a single vector.

An alternative to encoding motion information in this way would have been to explicitly track body pose in the spatiotemporal volume, as done in [2]. However, this involves detection of the body pose in individual frames which is subject to ambiguities caused by the projection from 3D to 2D as explained in the background art discussion and not having to do this is a contributing factor to the good results we will show in below in the results presented in Tables 1-6.

Another approach for spatiotemporal feature extraction could be to use 3D CNNs directly operating on the pixel intensities of the spatiotemporal volume. However, in our experiments, we have observed that, 3D CNNs did not achieve any notable improvement in performance compared to spatial CNNs. This is likely due to the fact that 3D CNNs remain stuck in local minima due to the complexity of the model and the large input dimensionality. This is also observed in [19, 26].

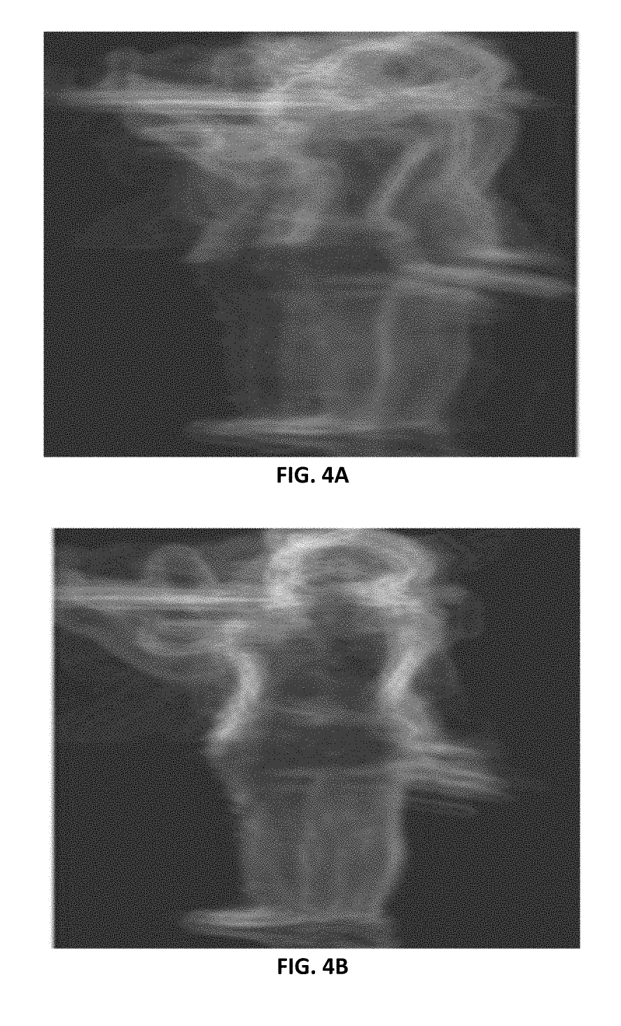

Regarding motion compensation with CNNs, for the 3D HOG descriptors introduced above to be representative of a pose of a person, the temporal bins must correspond to specific body parts, which implies that the person should remain centered from frame to frame in the bounding boxes used to build the image volume. In the present application, the Deformable Part Model detector (DPM) [10] is used to obtain these bounding boxes, as it proved to be effective in various applications. However, in practice, these bounding boxes may not be well-aligned on the person. Therefore, these boxes are shifted as shown in FIGS. 2A and 2B before creating a spatiotemporal volume. In FIGS. 4A and 4B, this feature is illustrated by showing heat maps of the gradients across a sequence without and with motion compensation. Without it, the gradients are dispersed across the region of interest, which reduces feature stability.

Accordingly, with one aspect of the present method, device, and system, an object-centric motion compensation scheme inspired by the one proposed in [32] for drone detection purposes, which was shown to perform better than optical-flow based alignment [28]. To this end, regressors are trained to estimate the shift of the person from the center of the bounding box. These shifts are applied to the frames of the image stack so that the subject remains centered, and obtain what is called a rectified spatio-temporal volume (RSTV), as depicted in FIG. 2B. CNNs are chosen as the regressors, as they prove to be effective in various regression tasks.

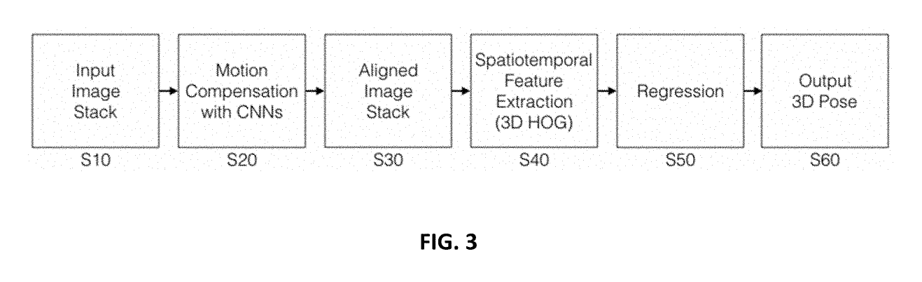

A schematic representation of the method as a flowchart, according to one aspect of the present invention, is shown in FIG. 3, depicting steps S10 to S60. First, a step S10 where an image stack is inputted to a processing device, for example by reading data from a memory, storage device, or from the network. Next, a step S20 is performed on the image stack, in which motion compensation is performed based on CNNs. This step S20 results in an aligned image stack in step S30 that can be stored for further data processing in a memory. Next, a step S40 is performed, in which the aligned image stack is processed by spatio-temporal feature extraction 3D HOG. Thereafter, the data is processed with a pose regression in a step S50, and in step S60, 3D poses can be output, for example as coordinate data or skeletons, and can be stored in a memory and displayed on a display screen.

More formally, let m be an image patch extracted from a bounding box returned by DPM. An ideal regressor ψ(.) for our purpose would return the horizontal and vertical shifts u and v of the person from the center of m: ψ(m)=(δu,δv). In practice, to make the learning task easier, two separate regressors ψ_{coarse} and ψ_{fine} are introduced. The first one is trained to handle large shifts and the second to refine them. These regressors are iteratively used as illustrated by the algorithm shown below that describes an object-centric motion compensation.

```
Input: image I, initial location estimate (i, j)
${ψ}_{*} ( \cdot ) = \{ \begin{matrix}{ψ}_{coarse} ( \cdot ) for the first 2 iterations , \\ {ψ}_{fine} ( \cdot ) for the other 2 ,\end{matrix}$
(i⁰, j⁰) = (i, j)
for o = 1 : MaxIter do
  (δu^{o}, δv^{o}) = ψ_{*}(I(i^{o-1}, j^{o-1})), with I(i^{o-1}, j^{o-1}) the image patch
  in I centered on (i^{o-1}, j^{o-1})
  (i^{o}, j^{o}) = (i^{o-1} + δu^{o}, j^{o-1} + δv^{o})
end for
(i, j) = (i^{MaxIter}, j^{MaxIter})
```

After each iteration, the images are shifted by the computed amount and estimate a new shift. This process typically takes only four (4) iterations, two (2) using ψ_{coarse} and two (2) using ψ_{fine}.

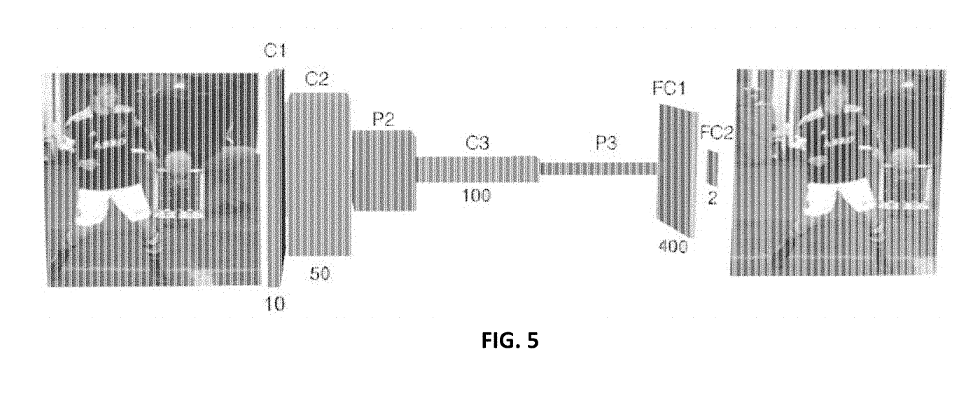

Both CNNs feature the same architecture, which includes fully connected, convolutional, and pooling layers, as schematically depicted by FIG. 2A and FIG. 5. Pooling layers are usually used to make the regressor robust to small image translations. However, while reducing the number of parameters to learn, they could negatively impact performance as our goal is precise localization. Therefore, pooling is not used at the first convolutional layer, only in the subsequent ones as depicted in FIG. 5. This yields accurate results while keeping the number of parameters small enough to prevent overfitting. Quantitatively, pooling layers (P2, P3) apply max-pooling operation to the 2×2 non-overlapping regions of the input feature map. The numbers below the convolutional layers (C1, C2 and C3) denote the number of filters of size 9×9 at the corresponding layers. After the convolutional and pooling layers, the features are further processed through a fully-connected layer of size 400. The output of the network is obtained through a final fully connected layer (FC2) of size 2. The output is a two-dimensional vector that describes the horizontal and vertical shifts of the person from the center of the patch.

Training the CNNs requires a set of image windows centered on a subject, shifted versions, such as the one depicted by FIG. 5, and the corresponding shift amounts (δu,δv). They are generated from training data by randomly shifting ground truth bounding boxes in horizontal and vertical directions. For ψ_{coarse} these shifts are large, whereas for ψ_{fine} they are small, thus representing the specific tasks of each regressor.

Using the CNNs requires an initial estimate of the bounding box for every person, which is given by DPM. However, applying the detector to every frame of the video is time consuming. Thus, the DPM is only applied to the first frame.

The position of the detection is then refined and the resulting bounding box is used as an initial estimate in the second frame. Similarly, its position is then corrected and the procedure is iterated in subsequent frames. The initial person detector provides rough location estimates and our motion compensation algorithm naturally compensates even for relatively large positional inaccuracies using the regressor, ψ_{coarse}. Some examples of our motion compensation algorithm, an analysis of its efficiency as compared to optical-flow.

Regarding the pose regression, a 3D pose estimation is casted in terms of finding a mapping Z→f(Z)≈Y, where Z is the 3D HOG descriptor computed over a spatiotemporal volume and Y is the 3D pose in its central frame. To learn f, Kernel Ridge Regression (KRR) [14] and Kernel Dependency Estimation (KDE) [8] have been considered, as they were used in previous works on this task [16, 17], as well as Deep Networks (DN).

The KRR trains a model for each dimension of the pose vector separately. To find the mapping from spatiotemporal features to 3D poses, it solves a regularized least-squares problem of the following form:

$$arg {min}_{W} {Σ}_{i} {‖ {Y}_{i} - W {Φ}_{Z} ( {Z}_{i} ) ‖}_{2}^{2} + {‖ W ‖}_{2}^{2} \qquad ( 5 )$$

where (Zᵢ, Y₁) are training pairs and Φ_{Z} is the Fourier approximation to the exponential-χ² kernel as in Ionescu. This problem can be solved in closed-form by W=(Φ_{Z}(Z)^{T}Φ_{Z}(Z)+I)⁻¹Φ_{Z}(Z)^{T}Y.

The KDE is a structured regressor that accounts for correlations in 3D pose space. To learn the regressor, not only the input as in the case of KRR, but also the output vectors are lifted into high-dimensional Hilbert spaces using kernel mappings Φ_{Z} and Φ_{Y}, respectively [8, 17]. The dependency between high dimensional input and output spaces is modeled as a linear function. The corresponding matrix W is computed by standard kernel ridge regression:

$$arg {min}_{W} {Σ}_{i} {‖ {Φ}_{Y} ( {Y}_{i} ) - W {Φ}_{Z} ( {Z}_{i} ) ‖}_{2}^{2} + {‖ W ‖}_{2}^{2} \qquad ( 6 )$$

To produce the final prediction Y, the difference between the predictions and the mapping of the output in the high dimensional Hilbert space is minimized by finding the following:

$$\hat{Y} = arg {min}_{Y} {‖ {W}^{T} {Φ}_{Z} ( Z ) - {Φ}_{Y} ( Y ) ‖}_{2}^{2} \qquad ( 7 )$$

Although the problem is non-linear and non-convex, it can nevertheless be accurately solved given the KRR predictors for individual outputs to initialize the process. In practice, an input kernel is used embedding based on 15,000-dimensional random feature maps corresponding to an exponential-χ² kernel, a 4000-dimensional output embedding corresponding to radial basis function kernel as shown in [24].

The DN rely on a multilayered architecture to estimate the mapping to 3D poses. Three (3) fully-connected layers are used with the rectified linear unit (ReLU) activation function in the first two (2) layers and a linear activation function in the last layer. The first two layers is made of 3000 neurons each and the final layer has fifty-one (51) outputs, corresponding to seventeen (17) 3D joint positions. Cross-validations were performed across the network's hyperparameters and the ones with the best performance on a validation set were chosen. The squared difference were minimized between the prediction and the ground-truth 3D positions to find the mapping f parametrized by Θ:

$$\hat{Θ} = arg {min}_{Θ} {Σ}_{i} {‖ {f}_{Θ} ( {Z}_{i} ) - {Y}_{i} ‖}_{2}^{2} \qquad ( 8 )$$

The ADAM [20] gradient update method was used to steer the optimization problem with a learning rate of 0.001 and dropout regularization to prevent overfitting. In the results section it is shown that the proposed DN-based regressor outperforms KRR and KDE [16, 17].

Next, the experimental results of the present method, device, and system were evaluated on the Human3.6m of Ionescu, HumanEva-I/II [36], and KTH Multiview Football II [6] datasets. Human3.6m is a recently released large-scale motion capture dataset that comprises 3.6 million images and corresponding 3D poses within complex motion scenarios. Eleven (11) subjects perform fifteen (15) different actions under four (4) different viewpoints. In Human3.6m, different people appear in the training and test data. Furthermore, the data exhibits large variations in terms of body shapes, clothing, poses and viewing angles within and across training/test splits [17]. The HumanEva-I/II datasets provide synchronized images and motion capture data and are standard benchmarks for 3D human pose estimation. Results on the KTH Multiview Football II dataset are further provided to demonstrate the performance of the present method, device, and system in a non-studio environment. In this dataset, the cameraman follows the players as they move around the pitch. Results of the present method are compared against several background art algorithms in these datasets. The datasets were chosen to be representative of different approaches to 3D human pose estimation, as discussed above. For those which there was not access to the code, the published performance numbers were used, and the present method was used on the corresponding data.

Regarding the evaluation on the Human3.6m dataset, to quantitatively evaluate the performance of the present method, device, and system, first the recently released Human3.6m [17] dataset was used. On this dataset, the regression-based method of [17] performed best at the time and therefore this method was used as a baseline. That method relies on a Fourier approximation of 2D HOG features using the χ² comparison metric, and it is herein referred as “e^{χ}^{²}-HOG+KRR” or “e^{χ}^{²}-HOG+KDE”, depending on whether it uses KRR or KDE. Since then, even better results have been obtained for some of the actions by using CNNs [25]. Herein it is referred as CNN-Regression. The procedure of the present method, device, and system is referred to as “RSTV+KRR”, “RSTV+KDE” or “RSTV+DN”, depending on whether KRR, KDE, or deep networks (DN) are used on the features extracted from the Rectified Spatiotemporal Volumes (RSTV). The pose estimation accuracy is reported in terms of average Euclidean distance between the ground-truth and predicted joint positions (in millimeters) as in Ionescu and Li and exclude the first and last T/2 frames (0.24 seconds for T=24 at 50 fps).

Li reported results on subjects S9 and S11 of Human3.6m and those of Ionescu made their code available. To compare our results to both of those baselines, we therefore trained our regressors and those of Ionescu for fifteen (15) different actions. In the present method, five (5) subjects (S1, S5, S6, S7, S8) were used for training purposes and two (2) (S9 and S11) for testing. Training and testing is carried out in all camera views for each separate action, as described in Ionescu. Recall from the discussion above that 3D body poses are represented by skeletons with seventeen (17) joints. Their 3D locations are expressed relative to that of a root node in the coordinate system of the camera that captured the images.

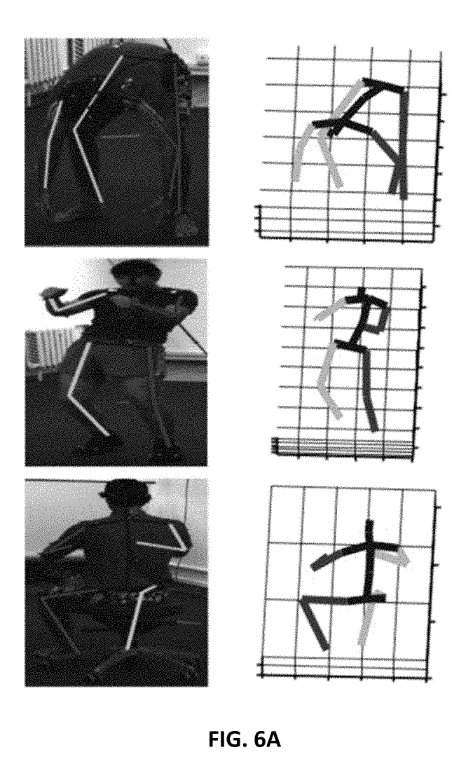

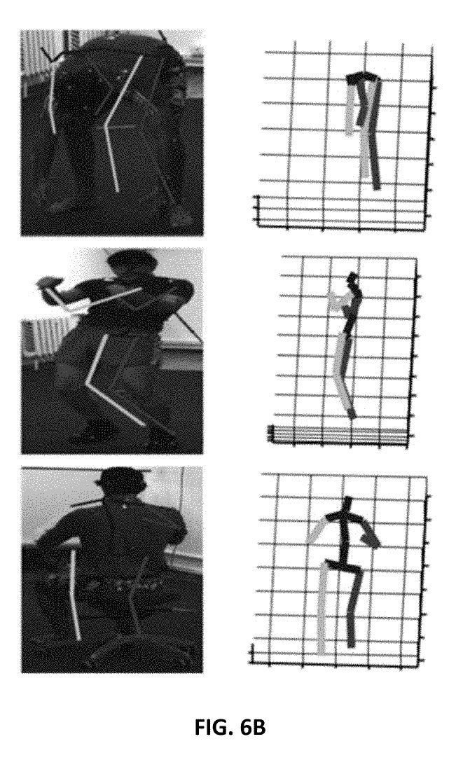

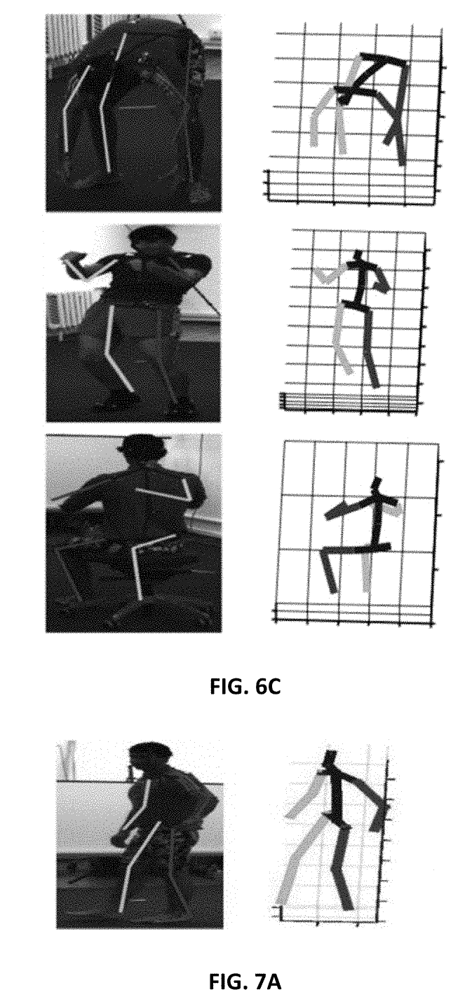

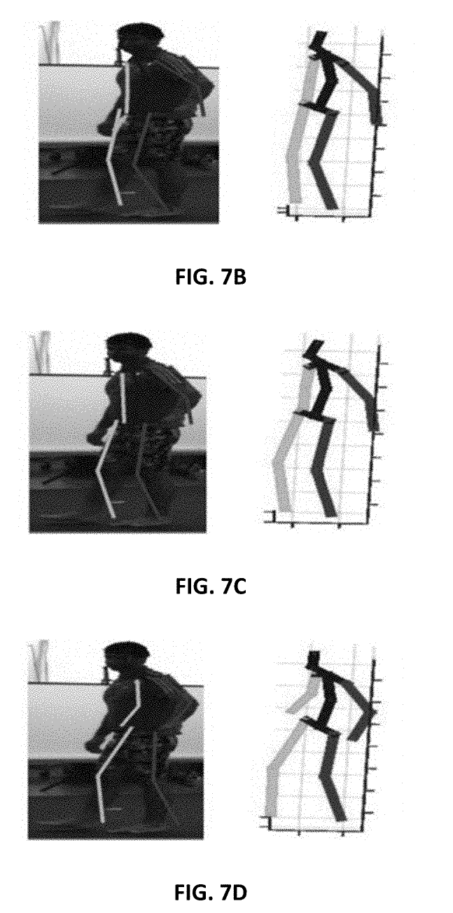

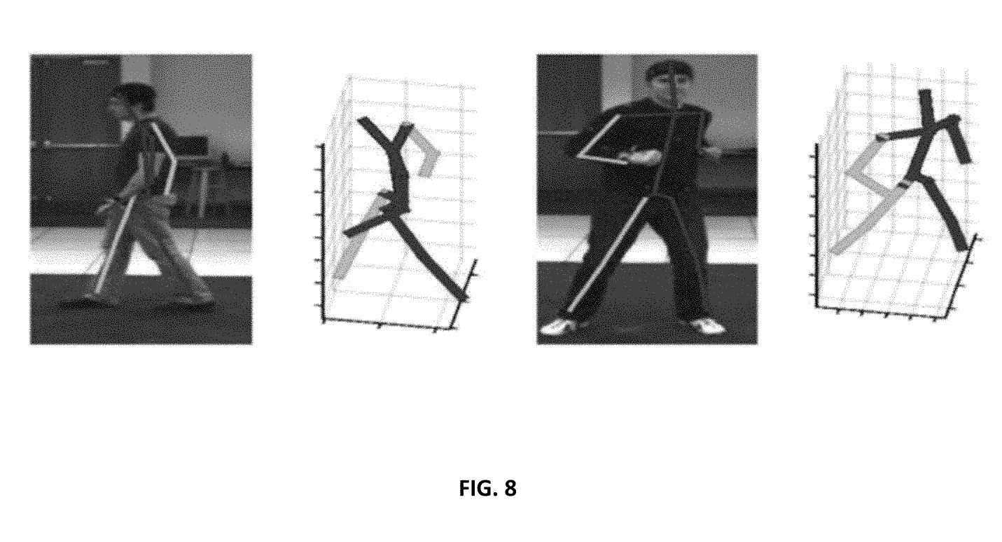

Table 1 summarizes our results on Human3.6m and FIGS. 6A-6C and 7A-7D depict some of them on selected frames. In Table 1 shows 3D joint position errors in Human3.6m using the metric of average Euclidean distance between the ground truth and predicted joint positions (in mm) to compare the results of the present method, obtained with the different regressors described in the section regarding the pose regression, as well as for those of Ionescu and Li. The present method, device, and system achieves significant improvement over the background discriminative regression approaches by exploiting appearance and motion cues from motion compensated sequences. ‘−’ indicates that the results are not reported for the corresponding action class. Standard deviations are given in parentheses. The sequence corresponding to Subject 11 performing Directions action on camera 1 in trial 2 is removed from evaluation due to video corruption.

Overall, our method significantly outperforms Ionescu's e^{χ}^{²}-HOG+KDE for all actions, with the mean error reduced by about 23%. It also outperforms the method of [16], which itself reports an overall performance improvement of 17% over e^{X2}-HOG+KDE and 33% over plain HOG+KDE on a subset of the dataset made of single images. Furthermore, it improves on CNN-Regression of Li by a margin of more than 5% for all the actions for which accuracy numbers are reported. The improvement is particularly marked for actions such as Walking and Eating, which involve substantial amounts of predictable motion. For Buying, Sitting and Sitting Down, using the structural information of the human body, RSTV+KDE yields better pose estimation accuracy. On twelve (12) out of fifteen (15) actions and in average over all actions in the dataset, RSTV+DN yields the best pose estimation accuracy.

In the following, the importance of motion compensation and of the influence of the temporal window size on pose estimation accuracy is analyzed. To highlight the importance of motion compensation, the features were recomputed without the motion compensation. We will refer to this method as STV. Also, a recent optical flow (OF) algorithm was tested for motion compensation [28].

Table 2 shows the results for two actions, which are representative in the sense that the Walking Dog one involves a lot of movement while subjects performing the Greeting action tend not to walk much. Even without the motion compensation, regression on the features extracted from spatiotemporal volumes yields better accuracy than the method of Ionescu. Motion compensation significantly improves pose estimation performance as compared to STVs. Furthermore, our CNN-based approach to motion compensation (RSTV) yields higher accuracy than optical-flow based motion compensation [28]. Table 2 therefore demonstrates the importance of motion compensation. The results of Ionescu are compared against the results of the present method, device, and system, without motion compensation and with motion compensation using either optical flow (OF) of [28] or the present method, device, and system.

Table 3 shows the influence of the size of the temporal window. In this table, the results of Ionescu against those obtained using the present method are compared, RSTV+DN, with increasing temporal window sizes. In these experiments, the effect of changing the size of our temporal windows from twelve (12) to forty-eight (48) frames is reported, again for two representative actions. Using temporal information clearly helps and the best results are obtained in the range of twenty four (24) to forty-eight (48) frames, which corresponds to 0.5 to 1 second at 50 fps. When the temporal window is small, the amount of information encoded in the features is not sufficient for accurate estimates. By contrast, with too large windows, overfitting can be a problem as it becomes harder to account for variation in the input data. Note that a temporal window size of twelve (12) frames already yields better results than the method of Ionescu. The experiments carried out on Human3.6m, twenty-four (24) frames were used as it yields both accurate reconstructions and efficient feature extraction.

Next, the present method was further evaluated on HumanEva-I and HumanEva-II datasets. The baselines that were considered are frame-based methods of [4, 9, 15, 22, 39, 38, 44], frame-to-frame-tracking approaches which impose dynamical priors on the motion [37, 41] and the tracking-by-detection framework of [2]. The mean Euclidean distance between the ground-truth and predicted joint positions is used to evaluate pose estimation performance. As the size of the training set in HumanEva is too small to train a deep network, RSTV+KDE was used, instead of RSTV+DN.

With the results shown in Tables 4 and 5 that using temporal information earlier in the inference process in a discriminative bottom-up fashion yields more accurate results than the above-mentioned approaches that enforce top-down temporal priors on the motion. Table 4 shows 3D joint position errors, in the example shown in mm, on the Walking and Boxing sequences of HumanEva-I. The results of the present method were compared against methods that rely on discriminative regression [4, 22], 2D pose detectors [38, 39, 44], 3D pictorial structures [3], CNN-based markerless motion capture method of [9] and methods that rely on top-down temporal priors [37, 41]. ‘-’ indicates that the results are not reported for the corresponding sequences.

For the experiments that were carried out on HumanEva-I, the regressor was trained on training sequences of Subject 1, 2 and 3 and evaluate on the “validation” sequences in the same manner as the baselines we compare against [3, 4, 9, 22, 37, 38, 39, 41, 44]. Spatiotemporal features are computed only from the first camera view. In Table 4, the performances of the present method, device, and system were reported on cyclic and acyclic motions, more precisely Walking and Boxing, and example 3D pose estimation results were depicted in FIG. 8. The results show that the present method, device, and system outperforms the background art approaches on this benchmark as well.

On HumanEva-II, the present method, device, and system was compared against [2, 15] as they report the best monocular pose estimation results on this dataset. HumanEva-II provides only a test dataset and no training data, therefore, the regressors were trained on HumanEva-I using videos captured from different camera views. This demonstrates the generalization ability of the present method, device, and system to different camera views. Following [2], subjects S1, S2 and S3 from HumanEva-I were used for training and report pose estimation results in the first 350 frames of the sequence featuring subject S2. Global 3D joint positions in HumanEva-I are projected to camera coordinates for each view. Spatiotemporal features extracted from each camera view are mapped to 3D joint positions in its respective camera coordinate system, as done in [29]. Whereas [2] uses additional training data from the “People” [30] and “Buffy” [11] datasets, only the training data from HumanEva-I was used. We evaluated the method by using the official online evaluation tool. Table 5 shows 3D joint position errors (in mm) on the Combo sequence of the HumanEva-II dataset. The results of the present method were compared against the tracking-by-detection framework of [2] and recognition-based method of [15]. ‘−’ indicates that the result is not reported for the corresponding sequence. As shown in the comparison of Table 5, the present method, device and system, achieves or exceeds the performance of the background art.

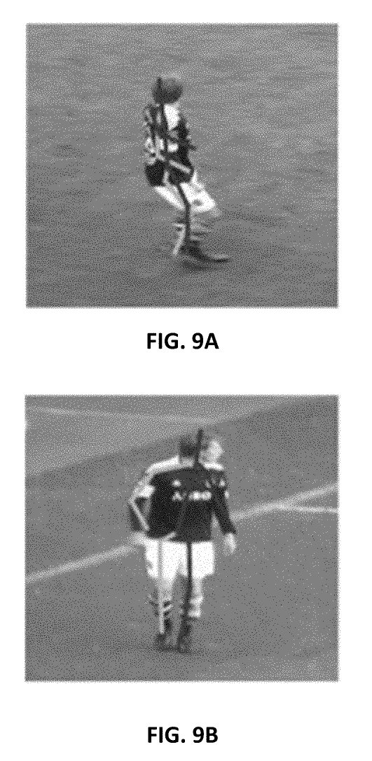

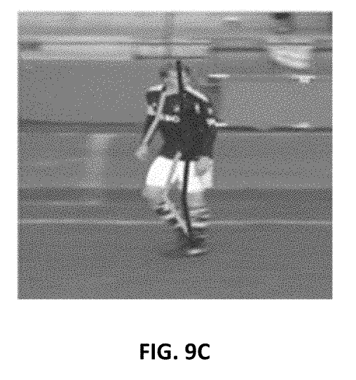

Moreover, the KTH Multiview Football Dataset has been evaluated with the present method, device, and system. As shown in [3, 6], the method was tested on the sequence containing Player 2. The first half of the sequence is used for training and the second half for testing, as in the original work [6]. To compare the results of the present method to those of [3, 6], pose estimation accuracy in terms of percentage of correctly estimated parts (PCP) score are reported. As in the HumanEva experiments, the results are provided for RSTV+KDE. FIGS. 9A to 9C depict example pose estimation results. Table 6 shows a comparison on the KTH Multiview Football II results of the present method using a single camera to those of [6] using either single or two cameras and to the one of [3] using two cameras. ‘−’ indicates that the result is not reported for the corresponding body part. As shown in Table 6, the baselines were outperformed even though our algorithm is monocular, whereas they use both cameras. This is due to the fact that the baselines instantiate 3D pictorial structures relying on 2D body part detectors, which may not be precise when the appearance-based information is weak. By contrast, collecting appearance and motion information simultaneously from rectified spatiotemporal volumes, we achieve better 3D pose estimation accuracy.

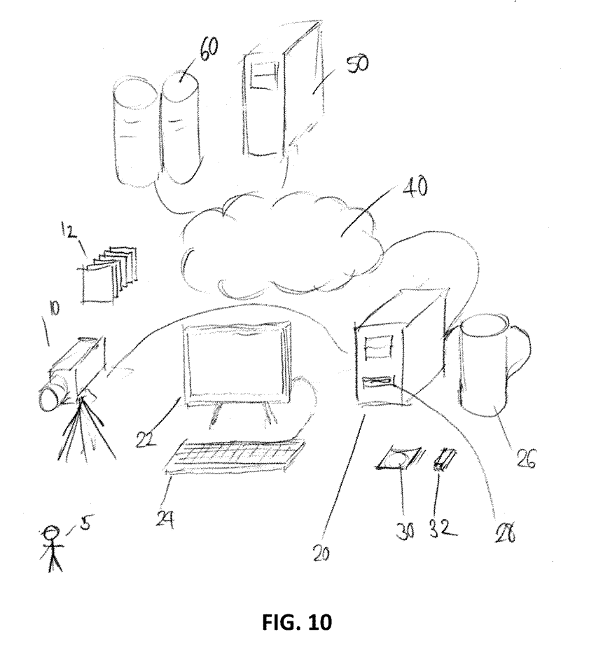

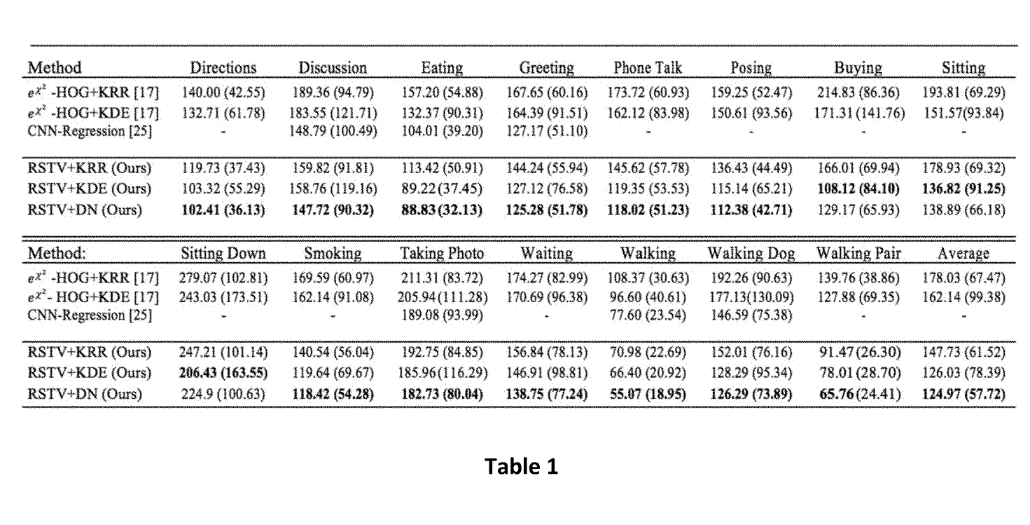

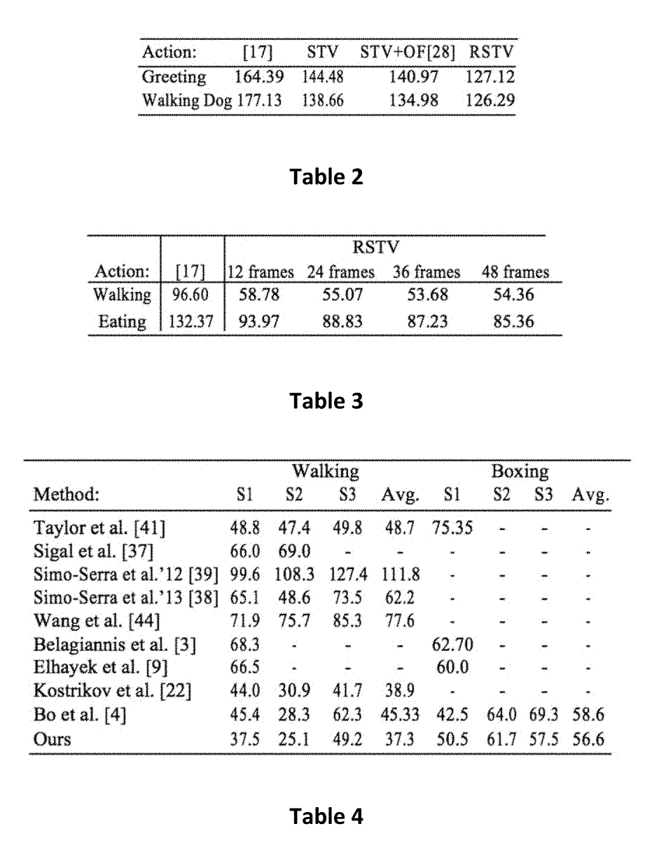

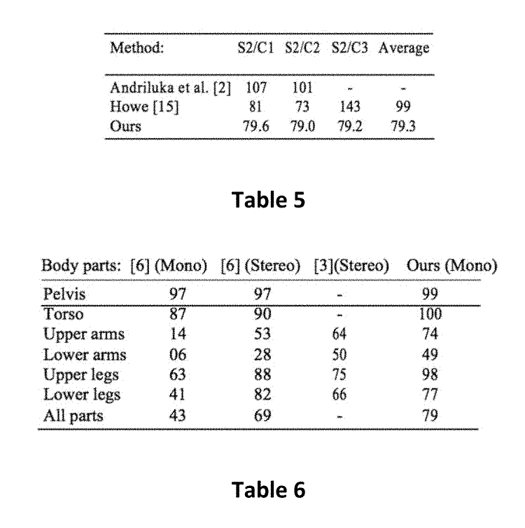

FIG. 10 shows an exemplary device and system for implementing the method described above, in an exemplary embodiment the method shown in FIG. 3. The system includes a camera 10, for example a video camera or a high-speed imaging camera that is able to capture a sequence of two-dimensional images 12 of a living being 5, the sequence of two dimensional images schematically shown with reference numeral 12. Living being 5 can be a human, performing different types of activities, typically sports, or an animal. In a variant, the living 5 could be an animal, but could also be a robotic device that performs human-like or animal-like movements. Camera 10 can be connected to a processing device 20, for example but not limited to a personal computer (PC), Macintosh™ computer, laptop, notebook, netbook. In a variant, the sequence of two-dimensional images 12 can be pre-stored on processing device 20, or can arrive to processing device 20 from the network. Processing device 20 can be equipped with one or several hardware microprocessors and with internal memory. Also, processing device 20 is connected to a data input device, for example a keyboard 24 to provide for user instructions for the method, and a data display device, for example a computer screen 22, to display different stages and final results of the data processing steps of the method. For example, three-dimensional human pose estimations and the central frame can be displayed on computer screen 22, and also the sequences of two-dimensional images 12. Processing device 20 is also connected to a network 40, for example the Internet, to access various cloud-based and network based services, for example but not limited to cloud or network servers 50, cloud or network data storage devices 60. The method described above can also be performed on hardware processors of one or more servers 50, and the results sent over the network 40 for rendering and display on computer screen 22 via processing device 20. Processing device 20 can be equipped with a data input/output port, for example a CDROM drive, Universal Serial Bus (USB), card readers, storage device readers, to read data, for example computer readable and executable instructions, from non-transitory computer-readable media 30, 32. Non-transitory computer-readable media 30, 32 are storage devices, for example but not limited to external hard drives, flash drives, memory cards, USB memory sticks, CDROM, Blu-Ray™ disks, optical storage devices and other types of portable memory devices that are capable of temporarily or permanently storing computer-readable instructions thereon. The computer-readable instructions can be configured to perform the method, as described above, when loaded to processing device 20 and executed on a processing device 20 or a cloud or other type of network server 50, for example the one shown in FIG. 10.

Accordingly, in the present application, it has been demonstrated that taking into account motion information very early in the modeling process yields significant performance improvements over doing it a posteriori by linking pose estimates in individual frames. It has been shown that extracting appearance and motion cues from rectified spatiotemporal volumes disambiguate challenging poses with mirroring and self-occlusion, which brings about substantial increase in accuracy over the background art methods on several 3D human pose estimation benchmarks. The proposed method is generic to different types of motions, and could be used for other kinds of articulated motions.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments, and be given the broadest reasonable interpretation in accordance with the language of the appended claims.

### REFERENCES

[1] A. Agarwal and B. Triggs. 3D Human Pose from Silhouettes by Relevance Vector Regression. In CVPR, 2004.
[2] M. Andriluka, S. Roth, and B. Schiele. Monocular 3D Pose Estimation and Tracking by Detection. In CVPR, 2010.
[3] V. Belagiannis, S. Amin, M. Andriluka, B. Schiele, N. Navab, and S. Ilic. 3D Pictorial Structures for Multiple Human Pose Estimation. In CVPR, 2014.
[4] L. Bo and C. Sminchisescu. Twin Gaussian Processes for Structured Prediction. IJCV, 2010.
[5] J. Brauer, W. Gong, J. Gonzalez, and M. Arens. On the Effect of Temporal Information on Monocular 3D Human Pose Estimation. In ICCV, 2011.
[6] M. Burenius, J. Sullivan, and S. Carlsson. 3D Pictorial Structures for Multiple View Articulated Pose Estimation. In CVPR, 2013.
[7] X. Burgos-Artizzu, D. Hall, P. Perona, and P. Dollar′. Merging Pose Estimates Across Space and Time. In BMVC, 2013.
[8] C. Cortes, M. Mohri, and J. Weston. A General Regression Technique for Learning Transductions. In ICML, 2005.
[9] A. Elhayek, E. Aguiar, A. Jain, J. Tompson, L. Pishchulin, M. Andriluka, C. Bregler, B. Schiele, and C. Theobalt. Efficient Convnet-Based Marker-Less Motion Capture in General Scenes with a Low Number of Cameras. In CVPR, 2015.
[10] P. Felzenszwalb, R. Girshick, D. McAllester, and D. Ramanan. Object Detection with Discriminatively Trained Part Based Models. PAMI, 2010.
[11] V. Ferrari, M. Martin, and A. Zisserman. Progressive Search Space Reduction for Human Pose Estimation. In CVPR, 2008.
[12] J. Gall, B. Rosenhahn, T. Brox, and H.-P. Seidel. Optimization and Filtering for Human Motion Capture. IJCV, 2010.
[13] S. Gammeter, A. Ess, T. Jaeggli, K. Schindler, B. Leibe, and L. Van Gool. Articulated Multi-Body Tracking Under Egomotion. In ECCV, 2008.
[14] T. Hofmann, B. Schlkopf, and A. J. Smola. Kernel Methods in Machine Learning. The Annals of Statistics, 2008.
[15] N. R. Howe. A Recognition-Based Motion Capture Baseline on the Humaneva II Test Data. MVA, 2011.
[16] C. Ionescu, J. Carreira, and C. Sminchisescu. Iterated Second-Order Label Sensitive Pooling for 3D Human Pose Estimation. In CVPR, 2014.
[17] C. Ionescu, I. Papava, V. Olaru, and C. Sminchisescu. Human3.6M: Large Scale Datasets and Predictive Methods for 3D Human Sensing in Natural Environments. PAMI, 2014.
[18] A. Kanaujia, C. Sminchisescu, and D. N. Metaxas. Semi-Supervised Hierarchical Models for 3D Human Pose Reconstruction. In CVPR, 2007.
[19] A. Karpathy, G. Toderici, S. Shetty, T. Leung, R. Sukthankar, and L. Fei-Fei. Large-Scale Video Classification with Convolutional Neural Networks. In CVPR, 2014.
[20] D. Kingma and J. Ba. Adam: A Method for Stochastic Optimisation. In ICLR, 2015.
[21] A. Klaser, M. Marszalek, and C. Schmid. A Spatio-Temporal Descriptor Based on 3D-Gradients. In BMVC, 2008.
[22] I. Kostrikov and J. Gall. Depth Sweep Regression Forests for Estimating 3D Human Pose from Images. In BMVC, 2014.
[23] I. Laptev. On Space-Time Interest Points. IJCV, 2005.
[24] F. Li, G. Lebanon, and C. Sminchisescu. Chebyshev Approximations to the Histogram Kernel. In CVPR, 2012.
[25] S. Li and A. B. Chan. 3D Human Pose Estimation from Monocular Images with Deep Convolutional Network. In ACCV, 2014.
[26] E. Mansimov, N. Srivastava, and R. Salakhutdinov. Initialization Strategies of Spatio-Temporal Convolutional Neural Networks. CoRR, abs/1503.07274, 2015.
[27] D. Ormoneit, H. Sidenbladh, M. Black, T. Hastie, and D. Fleet. Learning and Tracking Human Motion Using Functional Analysis. In IEEE Workshop on Human Modeling, Analysis and Synthesis, 2000.
[28] D. Park, C. L. Zitnick, D. Ramanan, and P. Dollar′. Exploring Weak Stabilization for Motion Feature Extraction. In CVPR, 2013.
[29] R. Poppe. Evaluating Example-Based Pose Estimation: Experiments on the Humaneva Sets. In CVPR, 2007.
[30] D. Ramanan. Learning to Parse Images of Articulated Bodies. In NIPS, 2006.
[31] D. Ramanan, A. Forsyth, and A. Zisserman. Strike a Pose: Tracking People by Finding Stylized Poses. In CVPR, 2005.
[32] A. Rozantsev, V. Lepetit, and P. Fua. Flying Objects Detection from a Single Moving Camera. In CVPR, 2015.
[33] B. Sapp, A. Toshev, and B. Taskar. Cascaded Models for Articulated Pose Estimation. In ECCV, 2010.
[34] J. Shotton, A. Fitzgibbon, M. Cook, and A. Blake. Real-Time Human Pose Recognition in Parts from a Single Depth Image. In CVPR, 2011.
[35] H. Sidenbladh, M. J. Black, and D. J. Fleet. Stochastic Tracking of 3D Human Figures Using 2D Image Motion. In ECCV, 2000.
[36] L. Sigal, A. Balan, and M. J. Black. Humaneva: Synchronized Video and Motion Capture Dataset and Baseline Algorithm for Evaluation of Articulated Human Motion. IJCV, 2010.
[37] L. Sigal, M. Isard, H. W. Haussecker, and M. J. Black. Loose-Limbed People: Estimating 3D Human Pose and Motion Using Non-Parametric Belief Propagation. IJCV, 2012.
[38] E. Simo-Serra, A. Quattoni, C. Torras, and F. Moreno-Noguer. A Joint Model for 2D and 3D Pose Estimation from a Single Image. In CVPR, 2012.
[39] E. Simo-Serra, A. Ramisa, G. Alenya, C. Torras, and F. Moreno-Noguer. Single Image 3D Human Pose Estimation from Noisy Observations. In CVPR, 2012.
[40] C. Sminchisescu, A. Kanaujia, Z. Li, and D. Metaxas. Discriminative Density Propagation for 3D Human Motion Estimation. In CVPR, 2005.
[41] G. W. Taylor, L. Sigal, D. J. Fleet, and G. E. Hinton. Dynamical Binary Latent Variable Models for 3D Human Pose Tracking. In CVPR, 2010.
[42] R. Urtasun and T. Darrell. Sparse Probabilistic Regression for Activity-Independent Human Pose Inference. In CVPR, 2008.
[43] R. Urtasun, D. Fleet, A. Hertzman, and P. Fua. Priors for People Tracking from Small Training Sets. In ICCV, 2005.
[44] C. Wang, Y. Wang, Z. Lin, A. L. Yuille, and W. Gao. robust Estimation of 3D Human Poses from a Single Image.
[45] D. Weinland, M. Ozuysal, and P. Fua. Making Action Recognition Robust to Occlusions and Viewpoint Changes. In ECCV, 2010.
[46] F. Zhou and F. de la Torre. Spatio-Temporal Matching for Human Detection in Video. In ECCV, 2014.
[47] S. Zuffi, J. Romero, C. Schmid, and M. J. Black. Estimating Human Pose with Flowing Puppets. In ICCV, 2013.

1. A method for predicting three-dimensional body poses from image sequences of an object, the method performed on a processor of a computer having memory, the method comprising the steps of:
accessing the image sequences from the memory;
finding bounding boxes around the object in consecutive frames of the image sequence;
compensating motion of the object to form spatio-temporal volumes; and
learning a mapping from the spatio-temporal volumes to a three-dimensional body pose in a central frame based on a mapping function.

2. The method according to claim 1, wherein the step of compensating motion includes centering the object in consecutive frames.

3. The method according to claim 1, wherein the mapping function uses a feature vector from the spatio-temporal volumes based on a histogram of oriented gradients (HOG) descriptor.

4. The method according to claim 3, wherein the HOG descriptor uses volume cells having different cell sizes.

5. The method according to claim 4, wherein in the step of compensating motion, convolutional neural net regressors are trained to estimate a shift of the object from a center of the bounding boxes.

6. The method according to claim 1, wherein the object is a living being.

7. A device for predicting three-dimensional body poses from image sequences of an object, the device including a processor having access to a memory, the processor configured to:
access the image sequences from the memory;
find bounding boxes around the object in consecutive frames of the image sequence;
compensate motion of the object to form spatio-temporal volumes; and
learn a mapping from the spatio-temporal volumes to a three-dimensional body pose in a central frame based on a mapping function.

8. The device according to claim 7, wherein in the compensating motion, the processor is configured to center the object in consecutive frames.

9. The device according to claim 7, wherein in the mapping function, the processor uses a feature vector from the spatio-temporal volumes based on a histogram of oriented gradients (HOG) descriptor.

10. The device according to claim 9, wherein for the HOG descriptor, the processor uses volume cells having different cell sizes.

11. The device according to claim 10, wherein in the compensating motion, the processor uses convolutional neural net regressors to estimate a shift of the object from a center of the bounding boxes.

12. The device according to claim 7, wherein the object is a living being.

13. A non-transitory computer readable medium, the computer readable medium having computer instructions recorded thereon, the computer instructions configured to perform a method for predicting three-dimensional body poses from image sequences of an object when executed on a computer having memory, the method comprising the steps of:
accessing the image sequences from the memory;
finding bounding boxes around the object in consecutive frames of the image sequence;
compensating motion of the object to form spatio-temporal volumes; and
learning a mapping from the spatio-temporal volumes to a three-dimensional body pose in a central frame based on a mapping function.

14. The non-transitory computer readable medium according to claim 13, wherein the step of compensating motion includes centering the object in consecutive frames.

15. The non-transitory computer readable medium according to claim 13, wherein the mapping function uses a feature vector from the spatio-temporal volumes based on a histogram of oriented gradients (HOG) descriptor.

16. The non-transitory computer readable medium according to claim 15, wherein the HOG descriptor uses volume cells having different cell sizes.

17. The non-transitory computer readable medium according to claim 16, wherein in the step of compensating motion, convolutional neural net regressors are trained to estimate a shift of the object from a center of the bounding boxes.

18. The non-transitory computer readable medium according to claim 13, wherein the object is a living being.
